(19) United States
(12) Patent Application Publication
(10) Pub. No.: US 2023/0413328 A1
(43) Pub. Date: Dec. 21, 2023

(54) Multi-link Flexible Target Wake Time with account for Cross-link Switching Delay

(71) Applicant: Ofinno, LLC, Reston, VA (US)

(72) Inventors: Jeongki Kim, Seoul (KR); Kiseon Ryu, McLean, VA (US); Esmael Hejazi Dinan, McLean, VA (US)

(73) Assignee: Ofinno, LLC, Reston, VA (US)

(21) Appl. No.: 18/139,977

(22) Filed: Apr. 27, 2023

Related U.S. Application Data
(60) Provisional application No. 63/337,654, filed on May 3, 2022.

(51) Int. Cl. H04W 74/08; H04W 74/04; H04W 52/02; H04W 72/12

(52) U.S. Cl. CPC H04W 74/0816; H04W 72/12; H04W 52/0274; H04W 74/04

(57) ABSTRACT

An access point (AP) multi-link device (MLD) transmits, to a station (STA) MLD, a first frame indicating a first start time of a target wake time (TWT) service period (SP) scheduled on a first link between the AP MLD and the STA MLD. The AP MLD transmits, to the STA MLD, on a second link between the AP MLD and the STA MLD, a second frame indicating a second start time of the TWT SP on the first link, where the second start time is based on a cross-link switching delay associated with the STA MLD.

### CROSS-REFERENCE TO RELATED APPLICATIONS

This application claims the benefit of U.S. Provisional Application No. 63/337,654, filed May 3, 2022, which is hereby incorporated by reference in its entirety.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of target wake time (TWT) operation.

FIG. 4 illustrates an example of TWT operation in an environment including an AP multi-link device (AP MLD) and a station multi-link device (STA MLD).

FIG. 5 illustrates an example TWT element which may be used to support individual TWT operation.

FIG. 6 illustrates an example TWT element which may be used to support restricted TWT (r-TWT) operation.

FIG. 7 illustrates an example of individual TWT operation.

FIG. 8 illustrates an example of broadcast TWT operation.

FIG. 9 illustrates an example of TWT protection in individual TWT operation.

FIG. 10 illustrates an example of r-TWT operation.

FIGS. 11A-B illustrate examples of flexible TWT operation.

FIG. 12 illustrates an example of TWT operation in a multi-link environment.

FIG. 13 illustrates an example of flexible TWT operation in a multi-link environment.

FIG. 14 illustrates another example of flexible TWT operation in a multi-link environment.

FIG. 15 illustrates an example of flexible TWT operation in a multi-link environment according to an embodiment.

FIG. 16 illustrates an example process according to an embodiment.

FIG. 17 illustrates an example process according to an embodiment.

FIG. 18 illustrates an example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

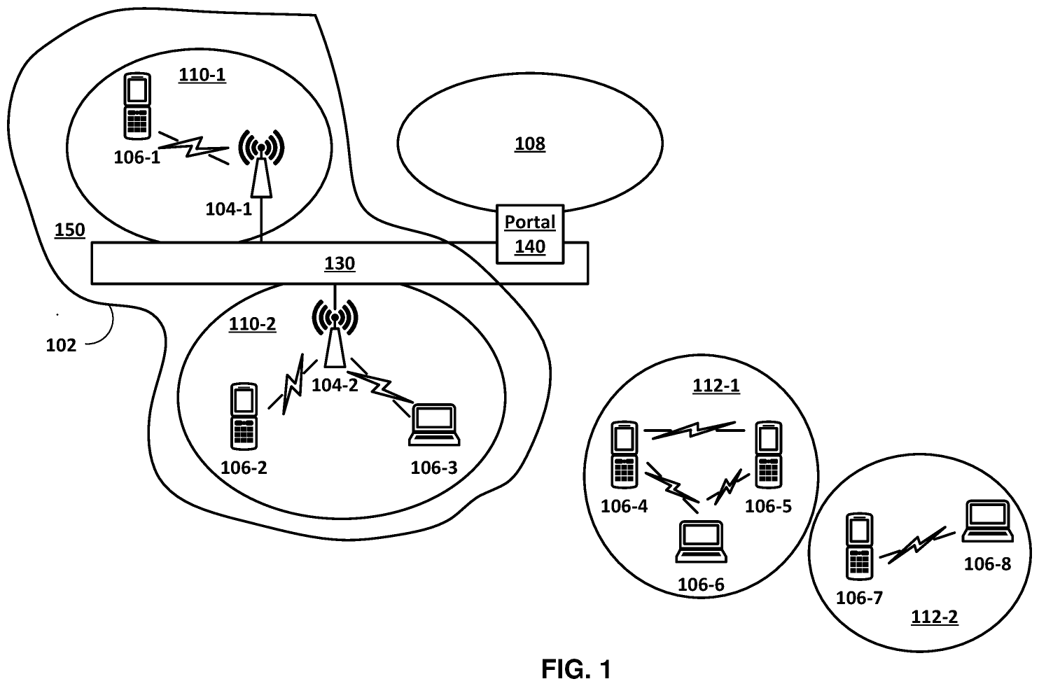

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 320 MHz by bonding together multiple 20 MHz channels.

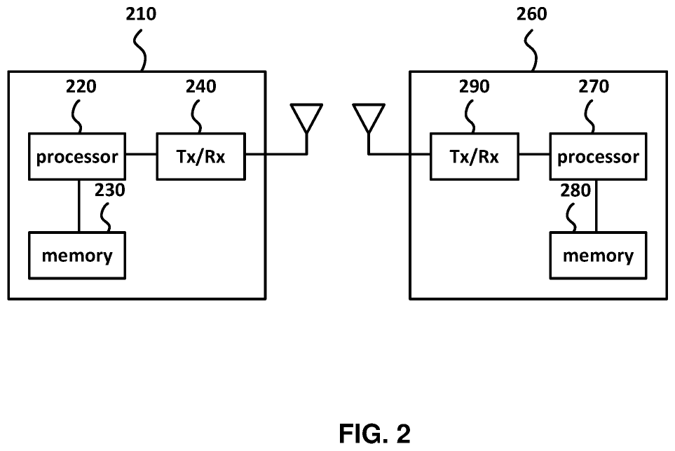

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

Target wake time (TWT), a feature introduced in the IEEE 802.11ah standard, allows STAs to manage activity in the BSS by scheduling STAs to operate at different times to reduce contention. TWTs may allow STAs to reduce the required amount of time that a STA utilizing a power management mode may be awake. TWTs may be individual TWTs or broadcast TWTs. Individual TWTs follow a negotiated TWT agreement between STAs. Broadcast TWTs are based on a schedule set and provided to STAs by an AP.

In an individual TWT, a STA that requests a TWT agreement is called a TWT requesting STA. The TWT requesting STA may be a non-AP STA for example. The STA that responds to the request is called a TWT responding STA. The TWT responding STA may be an AP for example. The TWT requesting STA is assigned specific times to wake up and exchange frames with the TWT responding STA. The TWT requesting STA may communicate wake scheduling information to the TWT responding STA. The TWT responding STA may transmit TWT values to the TWT requesting STA when a TWT agreement is established between them.

When explicit TWT is employed, the TWT requesting STA may wake up and perform a frame exchange. The TWT requesting STA may receive a next TWT information in a response from the TWT responding STA. When implicit TWT is used, the TWT requesting STA may calculate a next TWT by adding a fixed value to the current TWT value.

The TWT values for implicit TWT may be periodic. The TWT requesting STA operating with an implicit TWT agreement may determine a next TWT service period (TWT SP) start time by adding a value of a TWT wake interval associated with the TWT agreement to the value of the start time of the current TWT SP. The TWT responding STA may include the start time for a series of TWT SPs corresponding to a single TWT flow identifier of an implicit TWT agreement in a target wake time field of a TWT element. The TWT element may contain a value of ‘accept TWT’ in a TWT setup command field. The start time of the TWT SP series may indicate the start time of a first TWT SP in the series. Start times of subsequent TWT SPs may be determined by adding the value of the TWT wake interval to the start time of the current TWT SP. In an example, the TWT requesting STA, awake for an implicit TWT SP, may enter a doze state after the TWT SP has elapsed or after receiving an end of service period (EOSP) field equal to 1 from the TWT responding STA, whichever occurs first.

A TWT session may be negotiated between an AP and a STA. The TWT session may configure a TWT SP of DL and UL traffic between the AP and the STA. Expected traffic may be limited within the negotiated SP. The TWT SP may start at a specific time. The TWT SP may run for a SP duration. The TWT SP may repeat every SP interval.

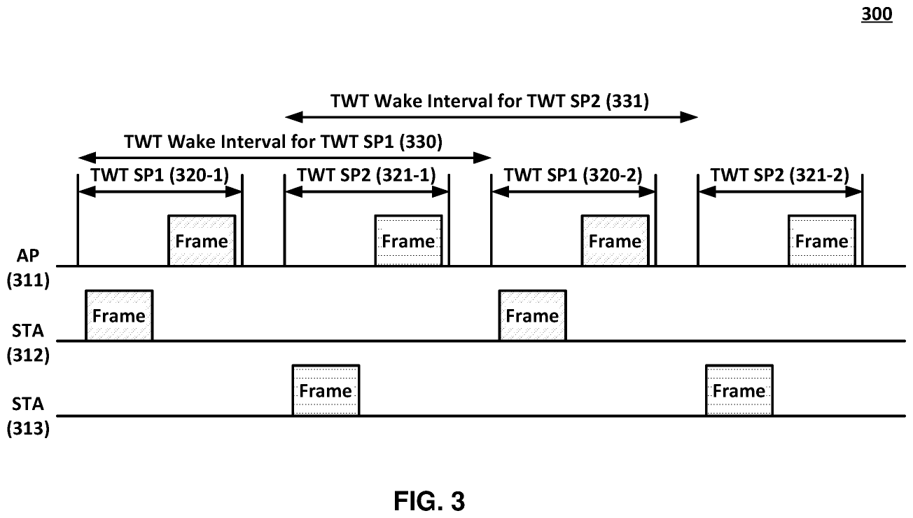

FIG. 3 illustrates an example 300 of TWT operation. As shown in FIG. 3, example 300 includes an AP 311, a STA 312, and a STA 313. AP 311 and STA 312 may establish a TWT SP 320. AP 311 and STA 313 may establish a TWT SP 321. TWT SP 320 and TWT SP 321 may repeat as shown in FIG. 3, such that TWT SP 320 may include a first TWT SP 320-1 and a second TWT SP 320-2, and such that TWT SP 321 may include a first TWT SP 321-1 and a second TWT SP 321-2.

AP 311 and STA 312 may exchange frames during first TWT SP 320-1. STA 312 may enter a doze state at the end of TWT SP 320-1 and may remain in the doze state until the start of second TWT SP 320-2. The start of second TWT SP 320-2 may be indicated by a TWT wake interval 330 associated with TWT SP 320. AP 311 and STA 312 may again exchange frames during second TWT SP 320-2.

Similarly, AP 311 and STA 313 may exchange frames during first TWT SP 321-1. STA 313 may enter a doze state at the end of first TWT SP 321-1 and may remain in the doze state until the start of second TWT SP 321-2. The start of second TWT SP 321-2 may be indicated by a TWT wake interval 331 associated with TWT SP 321. AP 311 and STA 313 may again exchange frames during second TWT SP 31-2.

In an awake state, a STA may be fully powered. The STA may transmit and/or receive a frame to/from an AP or another STA. In a doze state, a STA may not transmit and may not receive a frame to/from an AP or another STA.

An MLD is an entity capable of managing communication over multiple links. The MLD may be a logical entity and may have more than one affiliated station (STA). The MLD may have a single MAC service access point (MAC-SAP) to the LLC layer, which includes a MAC data service. An MLD may be an access point MLD (AP MLD) when a STA affiliated with the MLD is an AP STA (or an AP). An MLD may be a non-access point MLD (non-AP MLD) or STA MLD when a STA affiliated with the MLD is a non-AP STA (or a STA).

During negotiation of TWT agreements, a TWT requesting STA affiliated with a STA MLD and a TWT responding STA affiliated with an AP MLD may communicate multiple TWT elements. The TWT elements may comprise link ID bitmap subfields indicating different link(s) in a TWT setup frame. The TWT parameters provided by a TWT element may be applied to the respective link that is indicated in the TWT element.

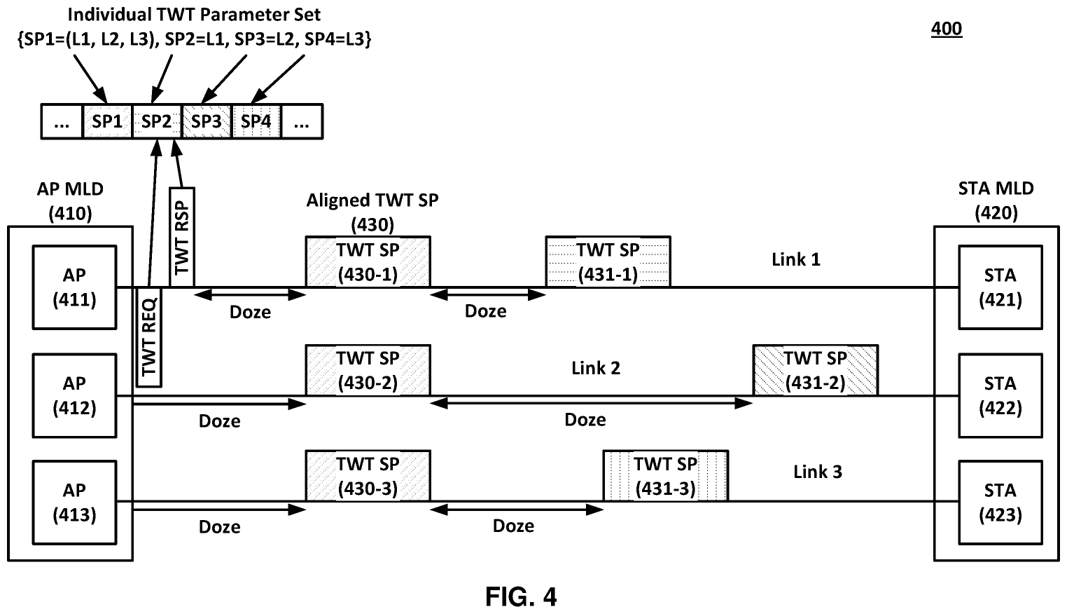

FIG. 4 illustrates an example 400 of TWT operation in a multi-link environment including an AP multi-link device (AP MLD) 410 and a STA multi-link device (STA MLD) 420. As shown in FIG. 4, AP MLD 410 may have three affiliated APs, AP 411, AP2 412, and AP3 413. In an example, AP 411, AP2 412, and AP3 413 may operate respectively on the 2.4 GHz band, the 5 GHz band, and the 6 GHz band. STA MLD 420 may have three affiliated STAs, STA 421, STA 422, and STA 423. In an example, STA 421, STA 422, and STA 423 may operate respectively on the 2.4 GHz band, the 5 GHz band, and the 6 GHz band. In an example, AP 411, AP2 412, and AP3 413 may be communicatively coupled via a first link (link 1), a second link (link 2), and a third link (link 3) respectively with STA 421, STA 422, and STA 423, respectively.

In an example, STA 421 may transmit a TWT request to AP 411. The TWT request may include three TWT elements. Each TWT element may indicate a respective link of links 1-3 and may request the setup of a TWT agreement for the indicated link. The three TWT elements may have different TWT parameters, such as target wake time (TWT). In response to the TWT request, AP 411 may transmit a TWT response to STA 421. The TWT response may include three TWT elements. Each TWT element may indicate a respective link of links 1-3 and may include a value of ‘accept TWT’ in a TWT setup command field.

Successful TWT agreement setup on links 1-3 establishes three TWT SPs with same or different TWT parameters on links 1-3 respectively. The target wake time field of the TWT element indicating a given link indicates the start time of the TWP SP for that link. The starting time may be indicated in reference to a time synchronization function (TSF) time of the link.

In example 400, initial TWT SPs 430-1, 430-2, and 430-3 of links 1-3 respectively may be aligned. TWT wake intervals associated with the TWT agreements of links 1-3 respectively may be set differently. As such, second TWT SPs 431-1, 431-2, and 431-3 of links 1-3 respectively may not be aligned. STA 421, STA 422, and STA 423 may enter a doze state between the end of initial TWT SPs 430-1, 430-2, and 430-3, respectively, and the start of second TWT SPs 431-1, 431-2, 431-3, respectively.

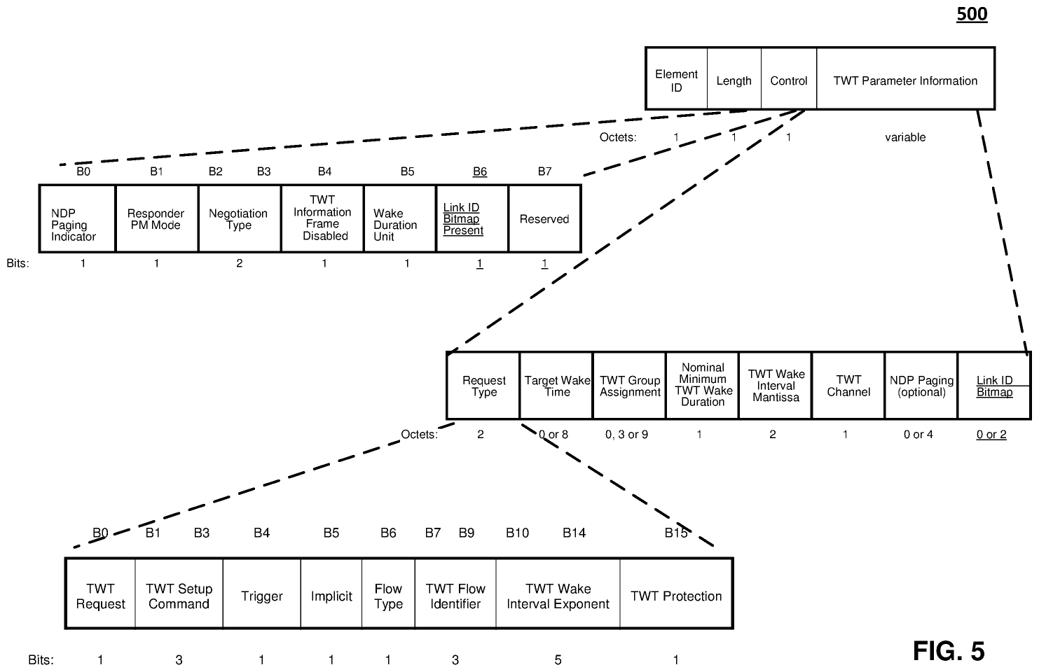

FIG. 5 illustrates an example target wake time (TWT) element 500 which may be used to support individual TWT operation.

In an example, an AP and a STA may use TWT element 500 to negotiate a TWT agreement. The AP and/or the STA may transmit TWT element 500 in an individually addressed management frame. The management frame may be of the type action, action no ack, (re)association request/response, and probe request response, for example.

The TWT schedule and parameters may be provided during a TWT setup phase. Renegotiation/changes of TWT schedules may be signaled via individually addressed frames that contain the updated TWT schedule/parameters. The frames may be management frames as described above or control or data frames that carry a field containing the updated TWT schedule/parameters.

Referring to FIG. 5, TWT element 500 includes an element ID field, a length field, a control field, and a TWT parameter information field.

The element ID field (e.g., 1 octet in length) may indicate that information element 500 is a TWT element. The length field (e.g., 1 octet) may indicate the length of TWT element 500 starting from the control field until an end of TWT element 500. The end of TWT element 500 may be the end of a TWT Channel field or the end of a Link ID bitmap field of the TWT parameter information field.

The TWT parameter information field may include a request type field (e.g., 2 octets), a target wake time field (e.g., 8 octets or less), a TWT group assignment field (e.g., 9, 3, 2, or 0 octets), a nominal minimal TWT wake duration field (e.g., 1 octet), a TWT wake interval mantissa (e.g., 2 octets), a TWT channel field (e.g., 1 octet), an optional NDP paging field (e.g., 0 or 4 octets), and/or a Link ID bitmaps field (e.g., 0 or 2 Octets).

The request type field may indicate a type of TWT request. The request type field may include a TWT request field (e.g., 1 bit), a TWT setup command field (e.g., 3 bits), a trigger field (e.g., 1 bit), an implicit field (e.g., 1 bit), a flow type (e.g., 1 bit), a TWT flow identifier (e.g., 3 bits), a TWT wake interval exponent (e.g., 5 bits), and/or a TWT protection field (e.g., 1 bit).

The TWT request field may indicate whether the TWT element 500 represents a request. If TWT request field has a value of 1, then the TWT element 500 may represent a request to initiate TWT scheduling/setup.

The TWT setup command field may indicate a type of TWT command. In a TWT request, the type of TWT command indicated may be: a request TWT (the TWT responding STA specifies the TWT value; e.g., field set to 0), a suggest TWT (the TWT requesting STA suggests a TWT value; e.g., field set to 1), and a demand TWT (the TWT requesting STA demands a TWT value; e.g., field set to 2).

In a TWT response, the type of TWT command indicated may be: TWT grouping (the TWT responding STA suggests TWT group parameters that are different than the suggested or demanded TWT parameters of the TWT requesting STA; e.g., field set to 3), accept TWT (the TWT responding STA accepts the TWT request with the TWT parameters indicated by the TWT requesting STA; e.g. field set to 4), alternate TWT (the TWT responding STA suggests TWT parameters that are different than the parameters suggested or demanded by the TWT requesting STA; e.g., field set to 5), dictate TWT (the TWT responding STA demands TWT parameters that are different than the parameters suggested or demanded by the TWT requesting STA; e.g., field set to 6), or reject TWT (the TWT responding STA rejects the TWT setup; e.g. field set to 7).

In a TWT response, the TWT command may also indicate an unsolicited response or a broadcast TWT. An unsolicited TWT response is an individually addressed frame that is intended for a specific STA. An unsolicited TWT response may be followed by an ACK frame from the STA receiving the unsolicited TWT response. A broadcast TWT may be intended for multiple STAs and may be carried in a broadcast frame such as, for example, a beacon frame. A broadcast TWT may not be acknowledged by receiving STAs.

An unsolicited TWT response may be used a TWT responding STA to demand that a recipient follow a TWT schedule contained in the TWT element. In an embodiment, an unsolicited TWT response may have the TWT request field set to 0 and a value of ‘dictate TWT’ in the TWT setup command field. A broadcast TWT response may be used by a TWT responding STA to schedule a TWT for any STA that receives and decodes the TWT element.

In certain embodiments, a TWT element, such as TWT element 500, may contain TWT parameter sets for multiple TWT negotiations or indications as described herein. As such, the TWT element may include multiple instances of the Control and the TWT parameter information fields. The TWT flow identifier of the request type field indicates the TWT negotiation which parameters are carried by the TWT parameter information field.

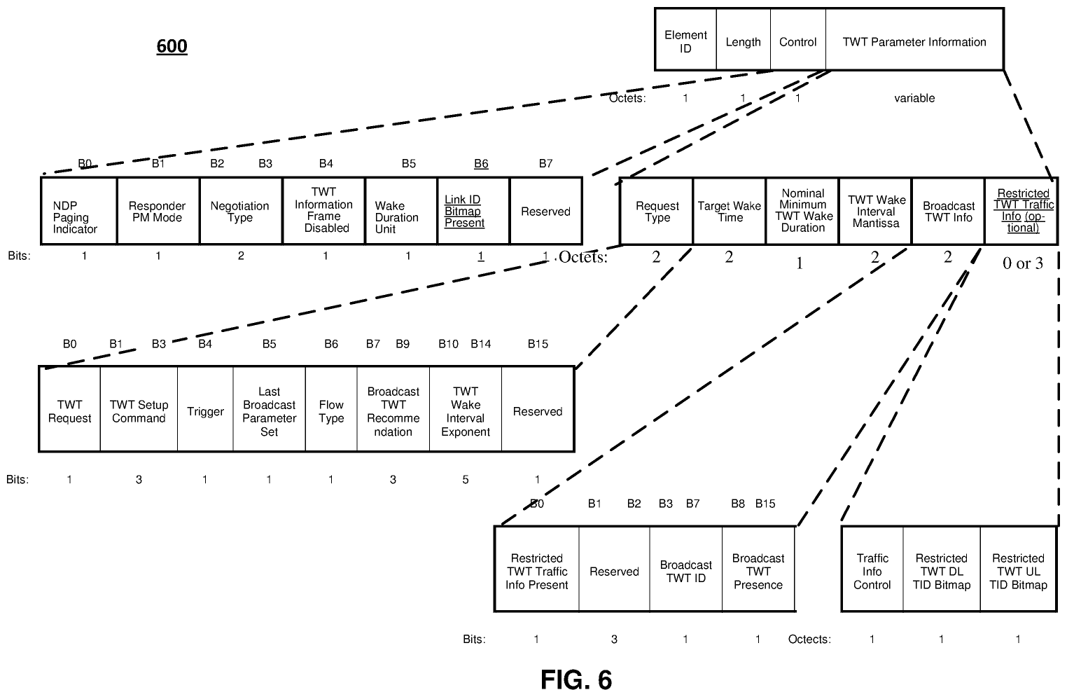

FIG. 6 illustrates an example target wake time (TWT) element 600 which may be used to support restricted TWT (r-TWT) operation. For r-TWT, TWT element 600 may be transmitted in a broadcast management frame, which can be a beacon frame, a TIM broadcast frame, a probe response frame, etc. In this embodiment, TWT element 600 provides non-negotiated TWT schedules (e.g., broadcast TWT schedules).

As shown, TWT element 600 includes an element ID field, a length field, a control field, and a TWT parameter information field.

The element ID field (e.g., 1 octet in length) may indicate that information element 600 is a TWT element. The length field (e.g., 1 octet) may indicate the length of TWT element 600 starting from the control field until an end of TWT element 600. The end of TWT element 600 may be the end of a broadcast TWT info field or the end of a r-TWT traffic info field of the TWT parameter information field.

The TWT parameter information field may include a request type field, a target wake time field (e.g., 2 octets), a nominal minimal TWT wake duration field (e.g., 1 octet), a TWT wake interval mantissa (e.g., 2 octets), a broadcast TWT info field (e.g., 2 octets), and an optional r-TWT traffic info field (e.g., 0 or 3 octets).

The request type field may include, among other fields, a TWT request field, a flow type field, and a TWT wake interval exponent field.

The TWT request field indicates whether TWT element 600 is a request. If the TWT request field has a value of 0, then TWT element 600 may represent a response to a request to initiate TWT scheduling/setup (solicit TWT), an unsolicited TWT response, and/or a broadcast TWT message.

The TWT wake interval represents the average time that a TWT requesting STA or a TWT scheduled STA expects to elapse between successive TWT SP start times of a TWT schedule. The TWT wake interval exponent field indicates a (base 2) exponent used to calculate the TWT wake interval in microseconds. In an embodiment, the TWT wake interval is equal to: (TWT wake interval mantissa)×2^{(TWT Wake Interval Exponent)}. The TWT wake interval mantissa value is indicated in microseconds, base 2 in a TWT wake interval mantissa field of the TWT parameter information field.

The nominal minimum TWT wake duration field may indicate the minimum amount of time (in the unit indicated by a wake duration unit subfield of the control field) that a TWT requesting STA or a TWT scheduled STA is expected to be awake to complete frame exchanges for the period of the TWT wake interval.

The flow type field, in a TWT response that successfully set up a TWT agreement between a TWT requesting STA and a TWT responding STA, may indicate a type of interaction between the TWT requesting STA and the TWT responding STA within a TWT SP of the TWT agreement. A flow type field equal to 0 may indicate an announced TWT. In an announced TWT, the TWT responding STA may not transmit a frame to the TWT requesting STA within a TWT SP until the TWT responding STA receives a PS-Poll frame or a QoS Null frame from the TWT requesting STA. A flow type field equal to 1 may indicate an unannounced TWT. In an unannounced TWT, the TWT responding STA may transmit a frame to the TWT requesting STA within a TWT SP before it has received a frame from the TWT requesting STA.

Within a TWT element that includes a TWT setup command value of ‘request TWT’, ‘suggest TWT’, or ‘demand TWT’, a broadcast TWT ID may indicate a specific broadcast TWT in which the TWT requesting STA is requesting to participate. Within a TWT element that includes a TWT setup command value of ‘accept TWT’, ‘alternate TWT’, ‘dictate TWT’, or ‘reject TWT’, a broadcast TWT ID may indicate a specific broadcast TWT for which the TWT responding STA is providing TWT parameters. The value 0 in the broadcast TWT ID subfield may indicate the broadcast TWT whose membership corresponds to all STAs that are members of the BSS corresponding to the BSSID of the management frame carrying the TWT element and that is permitted to contain trigger frames with random access resource units for unassociated STAs. The Broadcast TWT ID subfield in a r-TWT Parameter set field is always set to a nonzero value.

A broadcast TWT element 600 that contains a r-TWT parameter set is also referred to as a r-TWT element. A r-TWT traffic info present subfield of the broadcast TWT info field may be set to 1 to indicate the presence of the r-TWT traffic info field in TWT element 600. The r-TWT traffic info field is present in a r-TWT parameter set field when the r-TWT traffic info present subfield is set to 1.

The r-TWT traffic info field may include a traffic info control field, a r-TWT DL TID bitmap field, and a r-TWT UL TID bitmap field.

The traffic info control field may include a DL TID bitmap valid subfield and an UL TID bitmap valid subfield. The DL TID bitmap valid subfield indicates if the r-TWT DL TID bitmap field has valid information. When the value of the DL TID bitmap valid subfield is set to 0, it may indicate that DL traffic of TIDs is identified as latency sensitive traffic, and the r-TWT DL TID bitmap field is reserved. The UL TID bitmap valid subfield may indicate if the r-TWT UL TID bitmap field has valid information. When the value of the UL TID bitmap valid subfield is set to 0, it may indicate that UL traffic of TIDs is identified as latency sensitive traffic, and the r-TWT UL TID bitmap field is reserved.

The r-TWT DL TID bitmap subfield and the r-TWT UL TID bitmap subfield may specify which TID(s) are identified by the TWT scheduling AP or the TWT scheduled STA as latency sensitive traffic streams in a downlink and a uplink direction, respectively. A value of 1 at bit position k in the bitmap indicates that TID k is classified as a latency sensitive traffic stream. A value of 0 at bit position k in the bitmap indicates that TID k is not classified as a latency sensitive traffic stream.

An individual target wake time (TWT) may be a specific time or set of times negotiated between two individual stations (e.g., a STA and another STA, or a STA and an AP, etc.) at which the stations may be awake to exchange frames during a service period (SP) of the TWT.

In trigger-enabled TWT, an AP may transmit a trigger frame for scheduling uplink multi-user transmissions from one or more STAs using uplink OFDMA (orthogonal frequency division multiple access) and/or uplink MU-MIMO (multi-user multiple input multiple output) during a trigger-enabled TWT SP. A TWT STA that receives the trigger frame from the AP may transmit a frame to the AP through a resource indicated in the trigger frame during the trigger-enabled TWT SP.

In non-trigger-enabled TWT, an AP may not be required to transmit a trigger frame to schedule uplink multi-user transmissions from one or more STAs during a non-trigger-enabled TWT SP.

In announced TWT, a STA may transmit a frame (e.g., a PS-Poll frame or a QoS null frame) to the AP to retrieve a downlink buffered data from the AP during a TWT SP. In unannounced TWT, an AP may transmit downlink data to a TWT STA without receiving a frame (e.g., a PS-Poll frame, or a QoS null frame) from the TWT STA during a TWT SP.

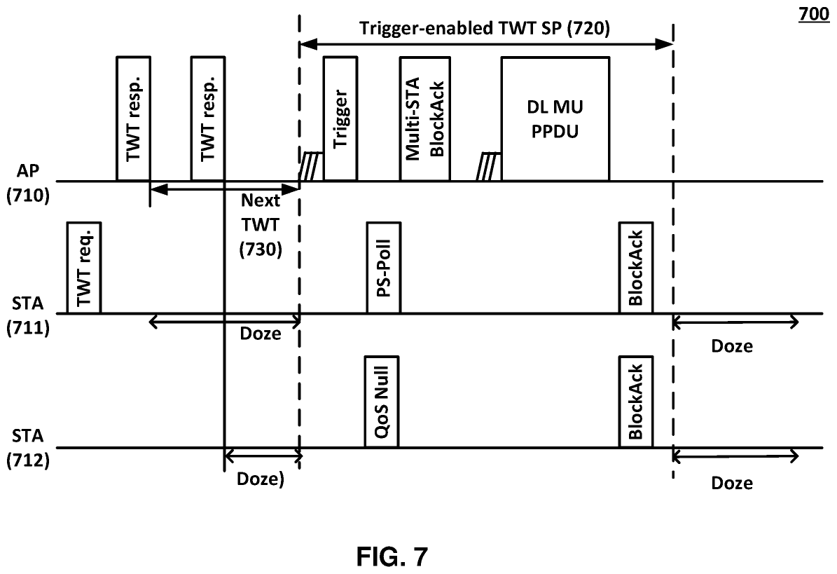

FIG. 7 illustrates an example 700 of individual TWT operation. As shown in FIG. 7, example 700 includes an AP 710, a STA 711, and a STA 712. In an example, AP 710 may be a TWT responding STA and STA 711 and STA 712 may be TWT requesting STAs.

In an example, STA 711 may transmit a TWT request to AP 710 to setup a first trigger-enabled TWT agreement. STA 711 may set a trigger field of the TWT request to 1 to indicate that it is requesting a trigger-enabled TWT. AP 710 may accept the first TWT agreement with STA 711. AP 710 may confirm the acceptance in a TWT response sent to STA 711. The TWT response may indicate a next TWT 730, which indicates the time until a next TWT SP 720 according to the first TWT agreement.

In an example, AP 710 may transmit an unsolicited TWT response to STA 712 to set up a second trigger-enabled TWT agreement with STA 712 without receiving a TWT request from STA 712. The first and second TWT agreements may be set up as announced TWTs.

After the setup of the TWT agreements, STA 711 and STA 712 may enter a doze state until the start of TWT SP 720. During trigger-enabled TWT SP 720, AP 710 may transmit a trigger frame. STA 711 and STA 12 may respond to the trigger frame by indicating that they are in awake state. In an example, STA 711 may transmit a power save poll (PS-Poll) frame. The PS-Poll frame may comprise a BSSID (receiver address: RA) field set to an address of AP 710 and a transmitter address (TA) field set to an address of STA 711. In an example, STA 712 may transmit a QoS null frame in response to the trigger frame. The QoS null frame may comprise a MAC header (e.g., a frame control field, a duration field, address fields, a sequence control field, QoS control field) without a frame body.

In response to the PS-Poll frame and the QoS null frame, AP 710 may transmit a multi-STA Block Ack (M-BA) frame. The M-BA frame may include acknowledgement information associated with the PS-Poll frame and the QoS null frame received from STAs 711 and 712 respectively. Subsequently, STA 711 and STA 712 may receive downlink bufferable units (DL BUs) from AP 710. The DL BUs may include a medium access control (MAC) service data unit (MSDU), an aggregate MAC service data unit (A-MSDU), and/or a bufferable MAC management protocol data unit (MMPDU). STA 711 and STA 712 may transmit Block Ack (BA) frames in response to the DL BUs. At the end of the TWT SP 720, STA 711 and STA 712 may return to a doze state.

A STA may execute individual TWT setup exchanges. The STA may not transmit frames to an AP outside of negotiated TWT SPs. The STA may not transmit frames that are not contained within high efficiency trigger-based physical protocol data units (HE TB PPDUs) to the AP within trigger-enabled TWT SPs. A HE TB PPDU may be transmitted by a STA based on receiving a trigger frame triggering uplink multi-user transmissions.

The AP of a trigger-enabled TWT agreement may schedule for transmission a trigger frame for a STA within the trigger-enabled TWT SP. The STA may transmit an HE TB PPDU as a response to the trigger frame sent during the trigger-enabled TWT SP. A STA that is in power save (PS) mode may include a PS-Poll frame or a QoS null frame in the HE TB PPDU if the TWT is an announced TWT, to indicate to the AP that the STA is currently in the awake state. The AP that receives the PS-Poll frame or the QoS Null frame or any other indication from an STA in PS mode, may deliver to the STA as many buffered BUs as are available at the AP during the TWT SP.

A broadcast target wake time (TWT) may be a specific time or set of times broadcast by an AP to one or more STAs at which the STAs may be awake to exchange frames with the AP during a SP of the TWT.

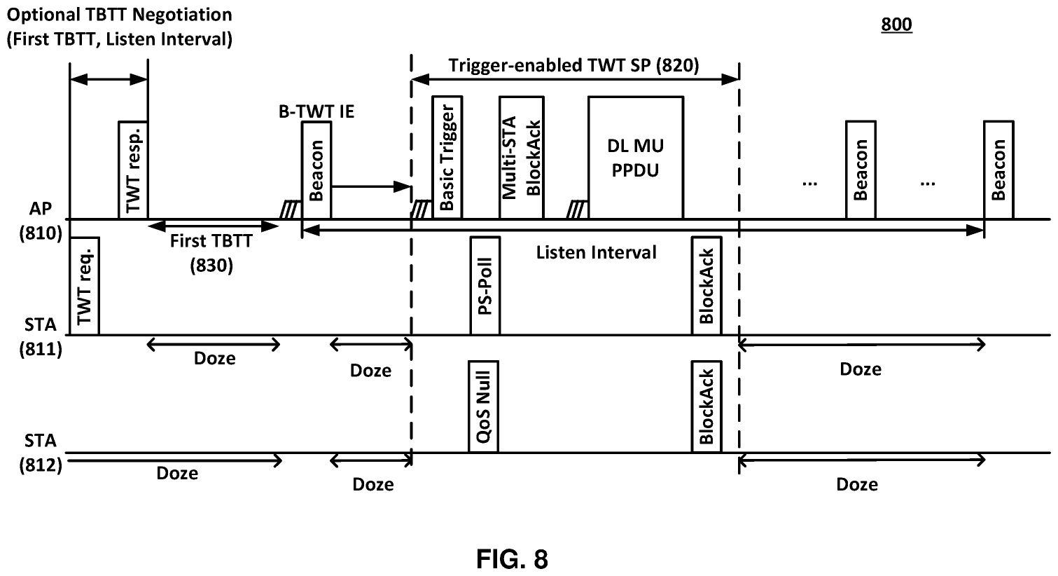

FIG. 8 illustrates an example 800 of broadcast TWT operation. As shown in FIG. 8, example 800 includes an AP 810, a STA 811, and a STA 812. In an example 800, AP 810 may be a TWT scheduling AP and STA 811 and STA 812 may be TWT scheduled STAs.

In an example, AP 810 may include a broadcast TWT element in a beacon frame that indicates a broadcast TWT SP 820. During the broadcast TWT SP 820, AP 810 may transmit trigger frames or DL BUs to STA 811 and STA 812. Beacon frames may be sent by AP 810 at a regular interval defined as the target beacon transmission time (TBTT). The TBTT is a time interval measured in time units (TUs). A TU is equal to 1024 microseconds.

In an example, STA 811 and STA 812 may enter a doze state until the first target beacon transmission time (TBTT). STA 811 and STA 812 may wake up to receive the beacon frame at the first TBTT to determine the broadcast TWT. Upon reception of a broadcast TWT element in a beacon frame, STA 811 and STA 812 may re-enter the doze state until the start of trigger-enabled TWT SP 820.

During trigger-enabled TWT SP 820, AP 810 may transmit a basic trigger frame to STA 811 and STA 812. STA 811 may indicate that it is awake by transmitting a PS-Poll, and STA 812 may indicate that it is awake by transmitting a QoS null frame in response to the basic trigger frame. Subsequently, STA 811 and STA 812 may receive DL BUs from AP 810. STA 811 and STA 812 may return to the doze state outside of the TWT SP 720.

In an example, a STA that intends to operate in power save mode may negotiate a wake TBTT and a wake interval with the AP. For example, as shown in FIG. 8, STA 811 may transmit a TWT request to AP 810 that identifies a wake TBTT of the first beacon frame and a wake interval between subsequent beacon frames. AP 810 may respond with a TWT response to the TWT request confirming the wake TBTT and wake interval. After successfully completing the negotiation, STA 811 may enter a doze state until a first negotiated wake TBTT 830. STA 811 may be in an awake state to listen to the beacon frame transmitted at first negotiated wake TBTT 830. If STA 811 receives a beacon frame from AP 810 at or after TBTT 830, STA 811 may return to the doze state until the next wake TBTT unless a traffic indication map (TIM) element in a beacon frame includes a positive indication for STA 811. The STA 811 may return to the doze state after a nominal minimum TBTT wake duration time has elapsed from the TBTT start time.

A Network Allocation Vector (NAV) is an indicator, maintained by a station (STA), of time periods when transmission onto the wireless medium (WM) may not be initiated by the STA regardless of whether the clear channel assessment (CCA) function of the STA senses that the WM is busy. A STA that receives at least one valid frame in a PSDU may update its NAV with the information from any valid duration field in the PSDU. The STA may update the NAV when a value of the received duration field is greater than the current NAV value of the STA.

A TWT protection is a mechanism employed to protect a TWT session from external STA transmissions. During a TWT SP configured to protect the TWT session, a STA that initiates a transmission opportunity (TXOP) to transmit a frame may transmit a request to transmit (RTS) frame or a clear to transmit (CTS) frame to protect the TWT session by setting the NAV of other STAs based on receiving of the RTS frame and/or the CTS frame. The RTS frame may comprise a frame control field, a duration field, a receiver address (RA) field, a transmitter address (TA) field, and a frame check sequence (FCS) field. The CTS frame may comprise a frame control field, a duration field, a receiver address (RA) field, and a frame check sequence (FCS) field.

The TWT protection field in a TWT element may indicate whether a TWT is protected or unprotected. A TWT requesting STA may set the TWT protection field to 1 to request the TWT responding STA to provide protection for the set of TWT SPs. A TWT protection field equal to 1 may indicate to use a NAV protection mechanism to protect access to the medium during the corresponding TWT SPs.

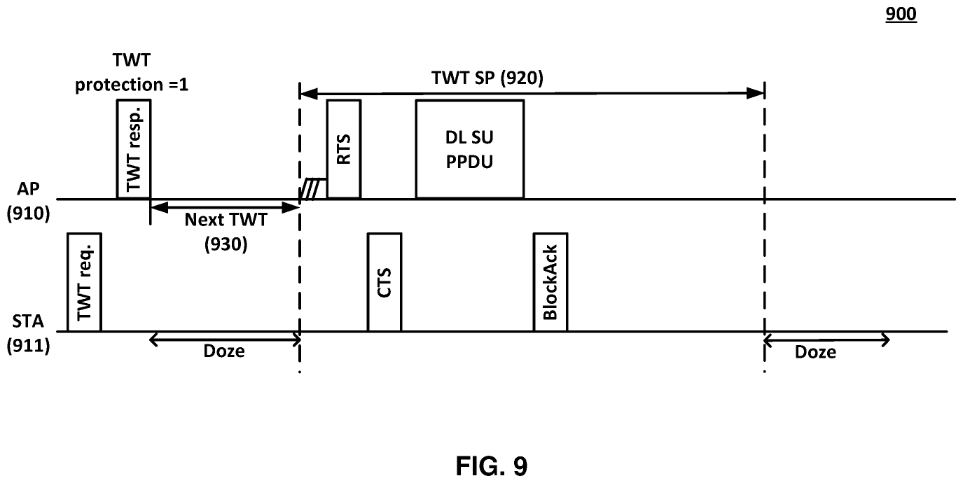

FIG. 9 illustrates an example 900 of TWT protection in individual TWT operation. As shown in FIG. 9, example 900 includes an AP 910 and a STA 911.

In an example, AP 910 may set the TWT protection field to 1 in a TWT response frame to protect the TWT SPs using a NAV protection mechanism. Upon reception of the TWT response frame, STA 911 may enter a doze state until the next TWT 930. AP 910 that has set the TWT protection field to 1 may transmit a NAV setting frame at the start of the TWT SP 920. For example, the NAV setting frame may be an RTS frame or a CTS frame.

A STA that receives the NV setting frame and that is not scheduled to access the medium during the TWT SP 920 may set their NAV according to the NAV setting frame. The STA may not access the medium for the specified amount of time in the NAV setting frame.

STA 911 may be scheduled to access the medium during the TWT SP 920. STA 911 may respond to the RTS frame with a CTS frame. Upon receiving the CTS frame, AP 910 may transmit a downlink frame to STA 911. STA 911 may respond to the downlink frame with a BA frame. When the TWT SP 920 ends, STA 911 may return to the doze state.

Traffic originating from many real time applications may have stringent latency requirements (e.g., very low average latency, worst-case latency on the order of a few to tens of milliseconds, and small jitter). Such traffic is referred to as latency sensitive traffic. R-TWT operation may allow an AP to use enhanced medium access protection and resource reservation mechanisms to provide more predictable latency, reduced worst case latency, and/or reduced jitter, with higher reliability for latency sensitive traffic.

Using TWT, a STA may negotiate awake periods with an AP to transmit and receive data packets. The STA may save power the rest of the time as the STA may remain in a doze state. TWT operation may thus lead to low power consumption for the participating STAs. TWT operation may also reduce the contention level and may support a collision-free and deterministic operation when STAs are distributed over different TWT sessions.

Using r-TWT (r-TWT) operation, an AP may allocate r-TWT SP(s) that may be used for transmission of data frames with latency sensitive traffic by the AP and one or more STAs. Traffic identifiers (TIDs) of latency sensitive traffic may be indicated in a broadcast frame (e.g., beacon frame, probe response frame, etc.) sent by the AP. The TIDs may be indicated in a r-TWT DL TID bitmap and/or a r-TWT UL TID bitmap of a r-TWT traffic info field of a TWT element. A data frame with a TID that is not identified as latency sensitive traffic may not be transmitted during an r-TWT SP.

A r-TWT scheduling AP, referred to as an r-TWT scheduling AP, may be an extremely high throughput AP (EHT AP) that supports r-TWT operation. A r-TWT scheduled STA, referred to as an r-TWT scheduled STA, is a non-AP EHT STA that supports r-TWT operation. When a r-TWT agreement is set up, the EHT AP may announce a r-TWT SP (r-TWT SP) schedule information in a broadcast TWT element. The broadcast TWT element may be contained in a management frame such as a beacon frame or a probe response frame.

The EHT AP may schedule a quiet interval that overlaps with a r-TWT SP. The quiet interval may have a duration of 1 TU. The quiet interval may start at the same time as the corresponding r-TWT SP. A quiet interval may be scheduled by including a quiet element in a beacon frame and/or a probe response frame. Legacy STAs may not be permitted to initiate a frame transmission during the quiet interval overlapping with the r-TWT SP.

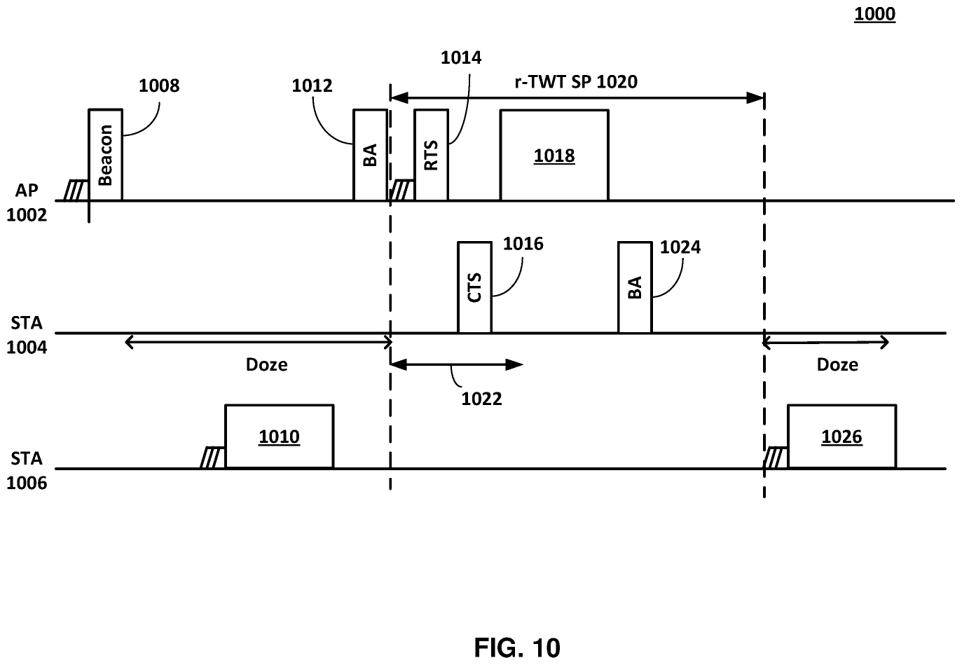

FIG. 10 illustrates an example 1000 of r-TWT operation. As shown in FIG. 10, example 1000 includes an AP 1002, a STA 1004, and a STA 1006.

In an example, an r-TWT agreement (hereinafter “r-TWT”) may be setup between AP 1002 and STA 1004. The r-TWT may not include STA 1006. For example, STA 1006 may be a legacy STA or an EHT STA not scheduled by AP 1002 as part of the r-TWT agreement.

In an example, AP 1002 may transmit a beacon frame 1008 including a TWT element that indicates an r-TWT SP 1020 of the setup r-TWT and TIDs allowed to be transmitted during the setup r-TWT. Beacon frame 1008 may also include a quiet element indicating a quiet interval 1022.

Upon receiving beacon frame 1008, STA 1004 may enter a doze state and may remain in the doze state until the start of r-TWT SP 1020. STA 1006, which is not scheduled by AP 1002 for r-TWT SP 1020, may transmit a data frame 1010 after receiving beacon frame 1008. However, STA 1006 must end its transmission before the start of r-TWT SP 1020. AP 1002 may transmit a BA frame 1012 in response to data frame 1010.

During r-TWT SP 1020, AP 1002 and STA 1004 may exchange an RTS frame 1014 and a CTS frame 1016. Subsequently, AP 1002 may send a data frame 1018 to STA 1004. Data frame 1018 includes traffic having a TID from among the TIDs indicated as permitted to transmit during r-TWT SP 1020 in beacon frame 1008. STA 1004 may respond with a BA frame 1024 to data frame 1018.

STA 1006 may not access the medium at least during quiet interval 1022 indicated in beacon frame 1008. When quiet interval 1022 or r-TWT SP 1020 ends, STA 1006 may resume transmission by transmitting a data frame 1026. STA 1004 may return to the doze state at the end of r-TWT SP 1020.

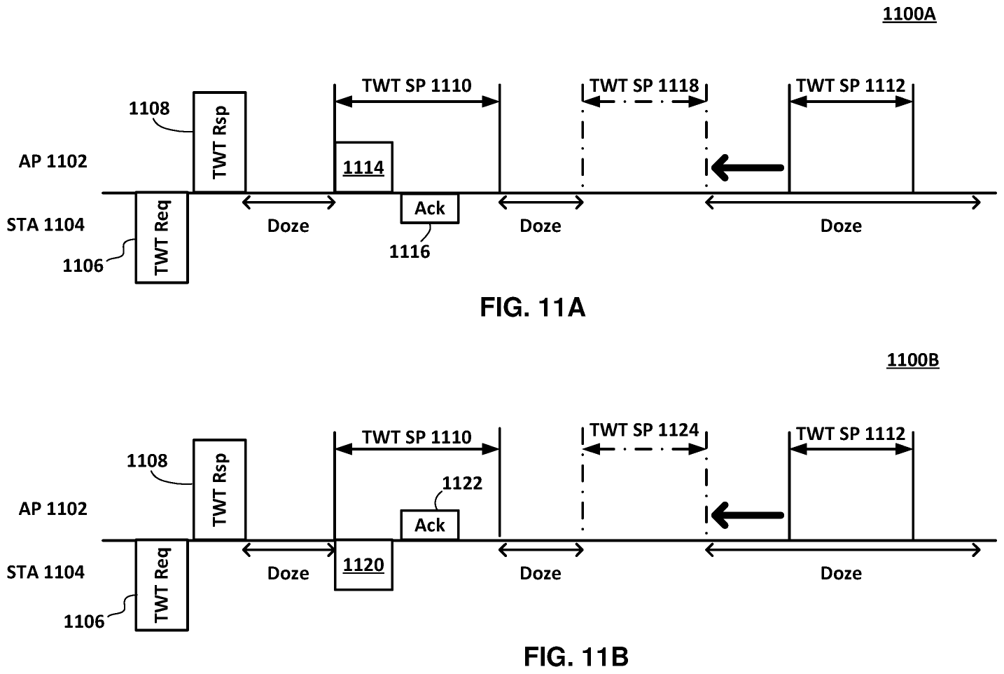

FIG. 11A illustrates an example 1100A of flexible TWT operation. As shown in FIG. 11A, example 1100A includes an AP 1102 and a STA 1104. STA 1104 may be associated with AP 1102.

As shown in FIG. 11A, STA 1104 may transmit a TWT setup request frame 1106 to AP 1102. TWT setup request frame 1106 may request the setup of a TWT for STA 1104. TWT setup request frame 1106 may include a TWT schedule for the requested TWT. The TWT schedule may include a start time of a first TWT SP of the TWT and a TWT wake interval. The start time of a subsequent TWT SP of the TWT may be determined by adding the TWT wake interval to the start time of the first TWT SP. For example, as shown in FIG. 11A, the requested TWT may include a first TWT SP 1110 and a second TWT SP 1112.

In response to TWT setup request frame 1106, AP 1102 may transmit a TWT setup response frame 1108 to STA 1104. In an example, AP 1102 may accept the setup of the requested TWT in TWT setup response frame 1108. In an example, TWT setup response frame 1108 may include a TWT element that includes a TWT flow identifier for the setup TWT. In an example, the TWT flow identifier may be set to 1.

In an embodiment, STA 1104 may enter a doze state after receiving TWT setup response frame 1108 and may remain in the doze state until the start time of first TWT SP 1110. STA 1104 may transition to an awake state at the start time of first TWT SP 1110.

According to flexible TWT operation, AP 1102 may reschedule one or more of the scheduled TWT SPs of the setup TWT. For example, as shown in FIG. 11A, AP 1102 may transmit, during TWT SP 1110, a frame 1114 to reschedule TWT SP 1112 as TWT SP 1118. Frame 1114 may include a modified start time of TWT SP 1112 (or, said differently, a start time of rescheduled TWT SP 1118). Frame 1114 may also include the TWT flow identifier of the setup TWT. In an embodiment, frame 1114 may be a TWT information frame. In an embodiment, the start time of rescheduled TWT SP 1118 may be indicated in a next TWT subfield of the TWT information frame. The next TWT subfield value may be set to a value “X” with reference to the time synchronization function (TSF). The start time of rescheduled TWT SP 1118 may be before or after the start time of initial TWT SP 1112.

STA 1104 may acknowledge frame 1114 by transmitting an ACK frame or BA frame 1116 to AP 1102. STA 1104 may replace a start time of TWT SP 1112 with the value indicated in frame 1114. In an embodiment, STA 1104 may preserve the power management (PM) mode from the time of receiving frame 1114 to the start time of rescheduled TWT SP 1118. That is, STA 1104 may remain in an awake state during TWT SP 1110 and may then enter into a doze state. STA 1104 may transition back to an awake state at the start time of rescheduled TWT SP 1118.

FIG. 11B illustrates another example 1100B of flexible TWT operation. As in example 1100A described above, example 1100B also includes AP 1102 and STA 1104. As described above for example 1100A, AP 1102 and STA 1104 exchange TWT setup frames 1106 and 1108 to setup a TWT for STA 1104. The setup TWT includes a first TWT SP 1110 and a second TWT SP 1112. STA 1104 may enter a doze state after receiving TWT setup response frame 1108 and may remain in the doze state until the start time of first TWT SP 1110. STA 1104 may transition to an awake state at the start time of first TWT SP 1110.

According to flexible TWT operation, STA 1104 may reschedule one or more of the scheduled TWT SPs of the setup TWT. For example, as shown in FIG. 11B, STA 1104 may transmit, during TWT SP 1110, a frame 1120 to reschedule TWT SP 1112 as TWT SP 1124. Frame 1120 may include a modified start time of TWT SP 1112 (or, said differently, a start time of rescheduled TWT SP 1124). Frame 1120 may also include the TWT flow identifier of the setup TWT. In an embodiment, frame 1120 may be a TWT information frame. In an embodiment, the start time of rescheduled TWT SP 1124 may be indicated in a next TWT subfield of the TWT information frame. The next TWT subfield value may be set to a value “X” with reference to the time synchronization function (TSF). The start time of rescheduled TWT SP 1124 may be before or after the start time of initial TWT SP 1112.

AP 1102 may acknowledge frame 1120 by transmitting an ACK or BA frame 1122 to AP 1102. Upon receiving frame 1122, STA 1104 may replace a start time of TWT SP 1112 with the value indicated in frame 1120. In an embodiment, STA 1104 may preserve the power management (PM) mode from the time of receiving frame 1122 to the start time of rescheduled TWT SP 1124. That is, STA 1104 may remain in an awake state during TWT SP 1110 and may then enter into a doze state. STA 1104 may transition back to an awake state at the start time of rescheduled TWT SP 1124.

As described above with reference to FIG. 4, in a multi-link environment, an AP MLD, having a plurality of affiliated APs, and a STA MLD, having a plurality of affiliated STAs, may be communicatively coupled through a plurality of links. Using one of the links, the AP MLD and the STA MLD may exchange TWT setup frames to setup one or more TWTs on one or more of the links. For example, the AP MLD and the STA MLD may setup a first TWT and a second TWT on a first link and a second link, respectively, of the plurality of links. The first TWT and the second TWT may or may not include aligned SPs. The first TWT and the second TWT may have respective TWT flow identifiers (e.g., 1 and 2).

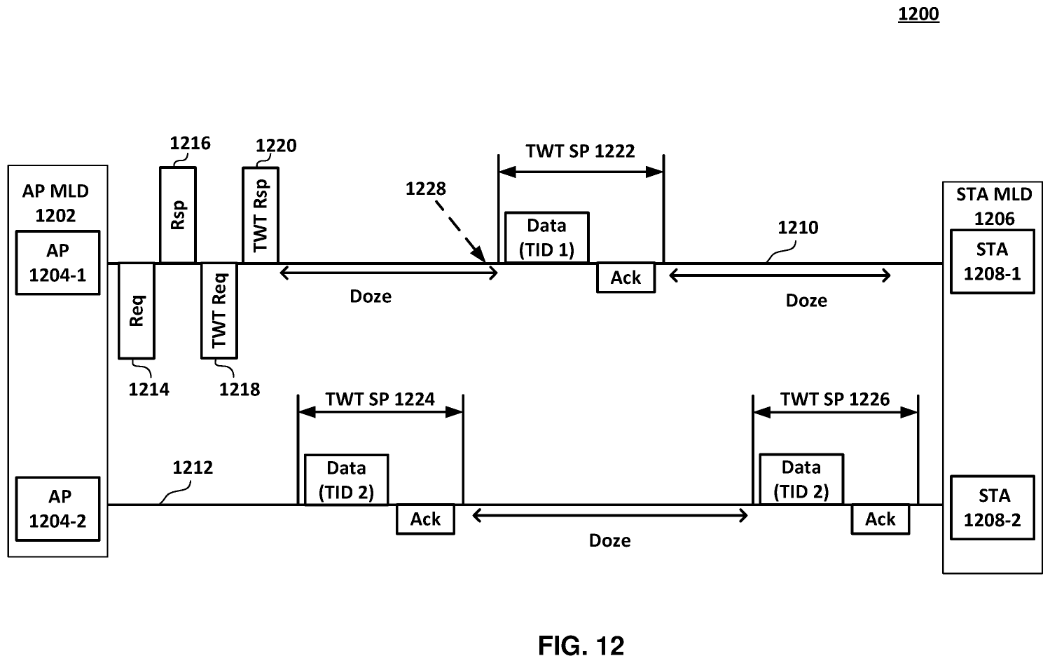

FIG. 12 illustrates an example 1200 of TWT operation in a multi-link environment. As shown in FIG. 12, example 1200 includes an AP MLD 1202 and a STA MLD 1206. AP MLD 1202 may have two affiliated APs 1204-1 and 1204-2. In an example, APs 1204-1 and 1204-2 may operate on respective frequency bands/channels. STA MLD 1206 may have two affiliated STAs 1208-1 and 1208-2. In an example, STAs 1208-1 and 1208-2 may operate on respective frequency bands/channels. In an example, APs 1204-1 and 1204-2 may be communicatively coupled via a first link 1210 and a second link 1212 respectively with STAs 1208-1 and 1208-2, respectively.

In an example, STA MLD 1206 may transmit, via STA 1208-1, a request frame 1214 on first link 1210. Request frame 1214 may be an association request frame or a TID-to-link mapping request frame. In an embodiment, request frame 1214 may include a first TID-to-link mapping. The first TID-to-link mapping maps UL/DL TIDs at STA MLD 1206 to links 1210 and 1212 between AP MLD 1202 and STA MLD 1206. For example, the first TID-to-link mapping may map a TID 1 to first link 1210 and a TID 2 to second link 1212.

In response to request frame 1214, AP MLD 1202 may transmit, via AP 1204-1, a response frame 1216 on first link 1210. Response frame 1216 may be an association response frame or a TID-to-link mapping response frame. In an embodiment, response frame 1216 may include a second TID-to-link mapping. The second TID-to-link mapping may be the same or different than the first TID-to-link mapping.

In an example, STA MLD 1206 may subsequently transmit, via STA 1208-1, a TWT setup request frame 1218 on first link 1210 to AP MLD 1202. TWT setup request frame 1218 may request the setup of a first TWT on first link 1210 and a second TWT on second link 1212. TWT request setup frame 1218 may include a respective TWT schedule for the first and second TWTs. TWT setup request frame 1218 may also indicate one or more TIDs to be associated with each of the requested TWTs. For example, TWT setup request frame 1218 may indicate TID 1 for the TWT requested on first link 1210 and TID 2 for the TWT requested on second link 1210. When TWT setup request frame 1218 includes TID information, the requested TWT is referred to as a restricted TWT (r-TWT) as only traffic having the indicated TID(s) may be transmitted during the SP(s) of the TWT.

In response to TWT setup request frame 1218, AP MLD 1202 may transmit, via AP 1204-1, a TWT setup response frame 1220 on first link 1210 to STA MLD 1206. TWT setup response frame 1220 may accept or modify the first and/or second TWT requested in TWT setup request frame 1218. TWT setup response frame 1220 may include a respective TWT flow identifier for each of the first and second TWTs (e.g., 1 and 2).

As shown in FIG. 12, the exchange of TWT setup frames 1218 and 1220 results in a first TWT, having at least a first TWT SP 1222, being setup on first link 1210, and in a second TWT, having at least a first TWT SP 1224 and a second TWT SP 1226, being setup on second link 1212.

In an example, based on the TID-to-link mapping, traffic associated with a TID 1 may be transmitted on first link 1210 during TWT SP 1222. For example, AP MLD 1202 may transmit, via AP 1204-1, a data frame (containing TID 1 traffic) to STA MLD 1206. STA MLD 1206 may acknowledge the data frame by transmitting an ACK frame or a BA frame, via STA 1208-1, to AP MLD 1202. Similarly, traffic associated with a TID 2 may be transmitted on second link 1212 during TWT SPs 1224 and 1226.

In an embodiment, STA MLD 1206 may be configured such that when a TWT is setup on a link, the affiliated STA on that link enters a doze state outside of the SP(s) of the setup TWT. For example, as shown in FIG. 12, STA 1208-1 may be configured to enter a doze state outside of TWT SP 1222. Similarly, STA 1208-2 may be configured to enter a doze state outside of TWT SPs 1224 and 1226.

In an example, at a time 1228 after or towards the end of TWT SP 1224 scheduled on second link 1212, TID 2 traffic may become available for transmission at AP MLD 1202 and/or STA MLD 1206. As only TID 1 is mapped to first link 1210, the TID 2 traffic may not be transmitted during TWT SP 1222 on first link 1210. The TID 2 traffic also may not be transmitted during TWT SP 1224 on second link 1212 (i.e., at the time 1228 towards the end of TWT SP 1224) as the remaining time of TWT SP 1224 may not be enough to transmit the TID 2 traffic. The TID 2 traffic may need to await the start of TWT SP 1226 on second link 1212. This may result in some or all of the traffic being dropped, particularly when the traffic is latency sensitive traffic.

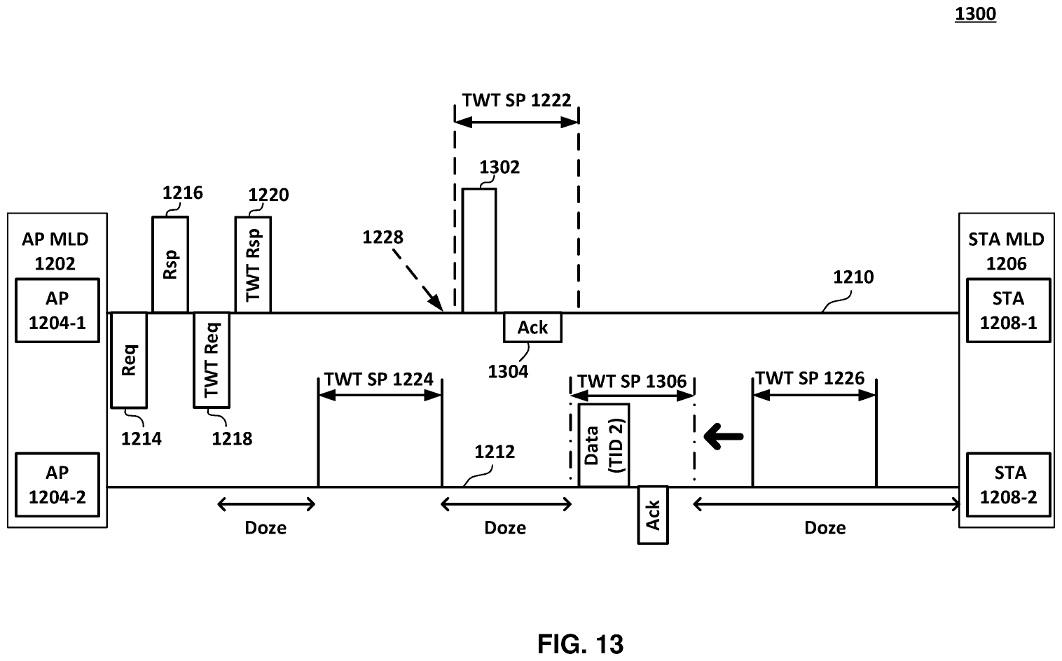

FIG. 13 illustrates another example 1300 of flexible TWT operation in a multi-link environment. As in example 1200 described above, example 1300 includes AP MLD 1202 and STA MLD 1206. As described above for example 1200, AP MLD 1202 and STA MLD 1206 may exchange request/response frames 1214 and 1216 to establish a TID-to-link mapping between AP MLD 1202 and STA MLD 1206. In an example, the TID-to-link mapping may map a TID 1 to first link 1210 and a TID 2 to second link 1212. AP MLD 1202 and STA MLD 1206 may also exchange TWT setup request/response frames 1218 and 1220 to setup a first TWT on first link 1210 and a second TWT on second link 1212. In an example, the first TWT includes a first TWT SP 1222, and the second TWT includes a first TWT SP 1224 and a second TWT SP 1226.

As in example 1200, at a time 1228 after or towards the end of TWT SP 1224 scheduled on second link 1212, TID 2 traffic may become available for transmission at AP MLD 1202 and/or STA MLD 1206. As only TID 1 is mapped to first link 1210, the TID 2 traffic may not be transmitted during TWT SP 1222 on first link 1210. The TID 2 traffic also may not be transmitted during TWT SP 1224 on second link 1212 (i.e., at the time 1228 towards the end of TWT SP 1224) as the remaining time of TWT SP 1224 may not be enough to transmit the TID 2 traffic. In an embodiment, to avoid having this traffic delayed (and potentially discarded) until the start of TWT SP 1226 on second link 1212, TWT SP 1226 may be rescheduled to start earlier on second link 1212.

In an example, AP MLD 1202 may transmit, on first link 1210, a frame 1302 to reschedule TWT SP 1226 as TWT SP 1306. Frame 1302 may be transmitted within or outside of TWT SP 1222 on first link 1210. Frame 1302 may be an existing action frame or an enhanced action. The existing action frame may be a TWT Information frame. Frame 1302 may include link ID information of second link 1212 and updated timing information for TWT SP 1226. In an example, the updated timing information is indicated in a next TWT subfield. The next TWT subfield value may be set to a value “X” with reference to the time synchronization function (TSF).

STA MLD 1206 may acknowledge frame 1302 by transmitting an ACK frame or BA frame 1304 to AP MLD 1202 on first link 1210. STA MLD 1206 may replace a start time of TWT SP 1226 with the value indicated in frame 1302. In an embodiment, STA MLD 1206 may preserve the power management (PM) mode from the time of receiving frame 1302 to the start time of rescheduled TWT SP 1306. For example, on second link 1212, STA 1208-2 may remain in a doze state and may transition to an awake state at the start time of rescheduled TWT SP 1306.

When TWT SP 1306 starts, AP MLD 1202 may transmit a data frame containing the buffered traffic for TID 2 on second link 1212. As such, the buffered traffic for TID 2 is transmitted with lower latency than in example 1200. STA MLD 1206 may acknowledge the data frame by transmitting an ACK on second link 1212. STA 1208-2 may return to a doze state at the end of TWT SP 1306 until the start of a subsequently scheduled TWT SP on second link 1212.

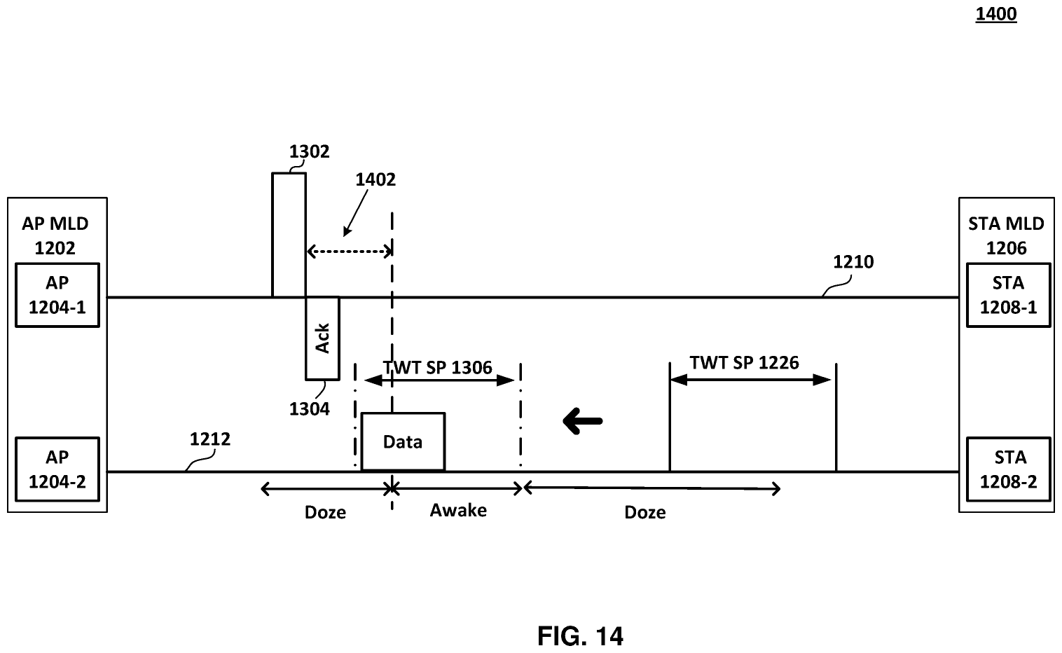

FIG. 14 illustrates another example 1400 of flexible TWT operation in a multi-link environment. As in example 1200 described above, example 1400 includes AP MLD 1202 and STA MLD 1206. As described above for example 1200, AP MLD 1202 and STA MLD 1206 may exchange request/response frames (not shown in FIG. 14) to establish a TID-to-link mapping between AP MLD 1202 and STA MLD 1206. In an example, the TID-to-link mapping may map a TID 1 to first link 1210 and a TID 2 to second link 1212. AP MLD 1202 and STA MLD 1206 may also exchange TWT setup request/response frames (not shown in FIG. 14) to setup a first TWT on first link 1210 and/or a second TWT on second link 1212.

In an example, the second TWT on second link 1212 includes TWT SP 1226. In an example, AP MLD 1202 may transmit, on first link 1210, frame 1302 to reschedule TWT SP 1226 as TWT SP 1306. Frame 1302 may or may not be transmitted during a TWT SP of the a first TWT setup on first link 1210. Frame 1302 may be an existing action frame or an enhanced action. Frame 1302 may include link ID information of second link 1212 and updated timing information for TWT SP 1226. In an example, the updated timing information is indicated in a next TWT subfield. The next TWT subfield value may be set to a value “X” with reference to the time synchronization function (TSF).

STA MLD 1206 may acknowledge frame 1302 by transmitting ACK frame or BA frame 1304 to AP MLD 1202 on first link 1210. STA MLD 1206 may replace a start time of TWT SP 1226 with the value indicated in frame 1302.

In an embodiment, STA MLD 1206 may preserve the power management (PM) mode from the time of receiving frame 1302 to the start time of rescheduled TWT SP 1306. For example, on second link 1212, STA 1208-2 may remain in a doze state after receiving frame 1302 and may transition to an awake state at the start time of rescheduled TWT SP 1306.

In implementation, STA MLD 1206 may require a minimum amount of time to switch STA 1208-2, operating on second link 1212, from a first power state (or first power management mode) to a second power state (or second power management mode) after receiving a command on first link 1210 (e.g., frame 1302) that triggers the transition from the first power state (or first power management mode) to the second power state (or second power management mode). This minimum amount of time, hereinafter referred to as cross-link switching delay, may vary from one STA MLD to another depending on device type (e.g., wireless terminal, fixed router, etc.), device class (e.g., transmit power class), or performance category (e.g., high-end versus low-end product).

In an example, the cross-link switching delay may include the time to receive the command (e.g., time to decode, parse, and process the command), the time for internal cross-link signaling of the command (e.g., from STA 1208-1 to STA MLD 1206 and from STA MLD 1206 to STA 1208-2), and the time for transitioning the STA (e.g., STA 1208-2) based on the command from the first power state (or first power management mode) to the second power state (or second power management mode). The first power state may be a doze state and the second power state may be an awake state, or vice versa. The first power management mode may be a power saving mode and the second power management mode may be an active mode, or vice versa.

Returning to example 1400, STA MLD 1206 may require a cross-link switching delay 1402 from the time of receiving frame 1302 on second link 1210, via STA 1208-1, until STA 1208-2 transitions from a doze state to an awake state. However, as shown in FIG. 14, AP MLD 1202 may reschedule TWT SP 1226 without account for this cross-link switching delay 1402. As such, rescheduled TWT SP 1306 may start before STA 1208-2 has transitioned from the doze state to the awake state. Data transmitted by AP MLD 1202 at the start of rescheduled TWT SP 1306 on second link 1212 may thus be lost.

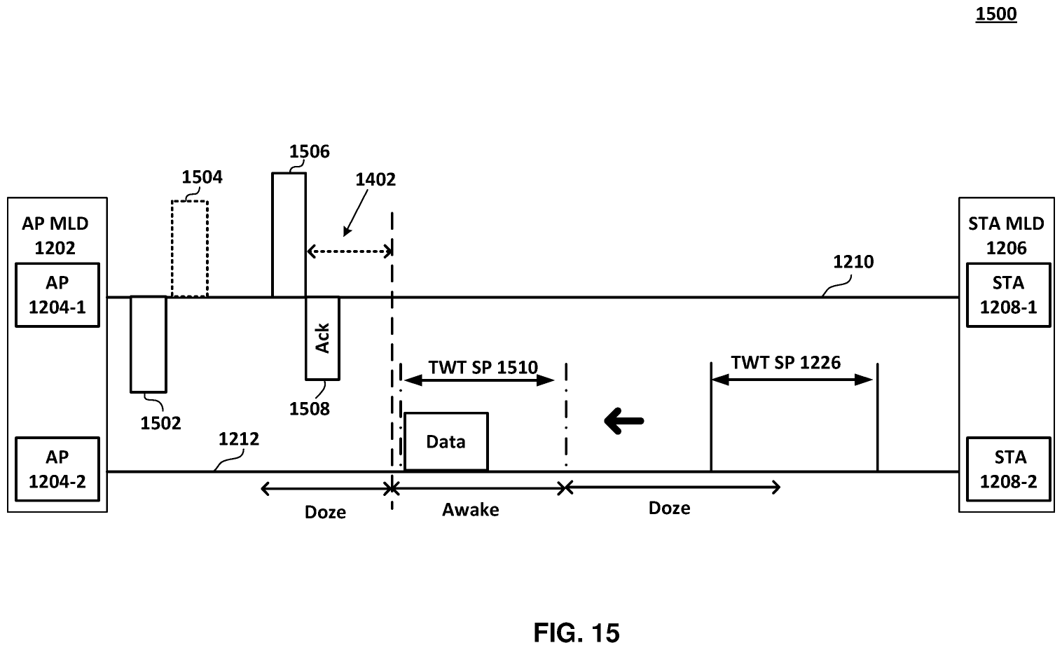

FIG. 15 illustrates an example 1500 of flexible TWT operation in a multi-link environment according to an embodiment. As in example 1200 described above, example 1400 includes AP MLD 1202 and STA MLD 1206. As described above for example 1200, AP MLD 1202 and STA MLD 1206 may exchange request/response frames (not shown in FIG. 15) to establish a TID-to-link mapping between AP MLD 1202 and STA MLD 1206. In an example, the TID-to-link mapping may map a TID 1 to first link 1210 and a TID 2 to second link 1212. AP MLD 1202 and STA MLD 1206 may also exchange TWT setup request/response frames (not shown in FIG. 15) to setup a first TWT on first link 1210 and/or a second TWT on second link 1212. In an example, the second TWT on second link 1212 includes TWT SP 1226.

In an embodiment, STA MLD 1206 may transmit a frame 1502 on first link 1210 to AP MLD 1202. Frame 1502 may include an indication of cross-link switching delay 1402 associated with STA MLD 1206. Frame 1502 may include, without limitation, a probe request frame, a TWT setup request frame, an association request frame, an action frame, a control frame, or a Quality of Service (QoS) data or null frame. Depending on the type of frame 1502, AP MLD 1202 may respond to frame 1502 by transmitting a frame 1504 on first link 1210 to STA MLD 1206. For example, frame 1504 may be a probe response frame, a TWT setup response frame, or an association response frame.

Subsequently, AP MLD 1202 may transmit a frame 1506 on first link 1210 to reschedule TWT SP 1226 on second link 1212. Frame 1506 may indicate a modified start time of TWT SP 1226 (or, said differently, a start time of a rescheduled TWT SP 1510). The modified start time of TWT SP 1226 may be based on cross-link switching delay 1402 associated with STA MLD 1206. In an embodiment, the modified start time is at least the cross-link switching delay 1402 after a transmission time of frame 1506 on first link 1210. In an example, the modified start time may be at least the cross-link switching delay 1402 after a transmission time of frame 1506 on first link 1210. AP MLD 1202 may use the indication of cross-link switching delay 1402 contained in frame 1502 to determine cross-link switching delay 1402 associated with STA MLD 1206.

Frame 1506 may include a TWT flow identifier of the TWT setup on second link 1212. In an embodiment, frame 1506 may be an existing action frame or a new action frame. The existing action frame may be a TWT information frame. In an embodiment, the start time of rescheduled TWT SP 1510 may be indicated in a next TWT subfield of the TWT information frame. The next TWT subfield value may be set to a value “X” with reference to the time synchronization function (TSF). The start time of rescheduled TWT SP 1510 may be before or after the start time of TWT SP 1226.

STA MLD 1206 may acknowledge frame 1506 by transmitting an ACK frame or BA frame 1508 to AP MLD 1202 on first link 1210. STA MLD 1206 may replace a start time of TWT SP 1226 with the value indicated in frame 1506. In an embodiment, STA MLD 1206 may preserve the power management (PM) mode from the time of receiving frame 1506 to the start time of rescheduled TWT SP 1510. For example, on second link 1212, STA 1208-2 may remain in a doze state and may transition to an awake state at the start time of rescheduled TWT SP 1510.

Because the start time of rescheduled TWT SP 1510 accounts for cross-link switching delay 1402, STA 1208-2 transitions from the doze state to the awake state before the start time of TWT SP 1510. When TWT SP 1510 starts, AP MLD 1202 may transmit a data frame, e.g., containing the buffered traffic for TID 2, on second link 1212. STA MLD 1206 may receive the data frame successfully via STA 1208-2. STA MLD 1206 may acknowledge the data frame by transmitting an ACK or a BA frame (not shown) on second link 1212. STA 1208-2 may return to a doze state at the end of TWT SP 1510 until the start of a subsequently scheduled TWT SP on second link 1212.

In an embodiment, the indication of cross-link switching delay 1402 in frame 1502 is a value of cross-link switching delay 1402 associated with STA MLD 1206. In other words, frame 1502 includes the value of cross-link switching delay 1402 associated with STA MLD 1206. The value of cross-link switching delay 1402 may be a pre-configured parameter of STA MLD 1206 or may be determined by STA MLD 1206. For example, STA MLD 1206 may determine cross-link switching delay 1402 based on a device class of STA MLD 1206. The device class may be as defined in section 36.3.16 of IEEE 802.11be (e.g., Class A or Class B) or an enhanced device class based on a performance category of STA MLD 1206 (e.g., Class 1: high-end performance, Class 2: medium performance, Class 3: low-end performance. Alternatively or additionally, STA MLD 1206 may determine cross-link switching delay 1402 based on another delay value pre-configured at STA MLD 1206. For example, STA MLD 1206 may determine cross-link switching delay 1402 based on an Enhanced Multi-Link Single Radio (EMLSR) delay associated with STA MLD 1206. Cross-link switching delay 1402 may be determined as a fraction or a multiple of the EMLSR associated with STA MLD 1206.

In another embodiment, the indication of cross-link switching delay 1402 in frame 1502 may be a device class associated with STA MLD 1206. As mentioned above, the device class may be as defined in section 36.3.16 of IEEE 802.11be (e.g., Class A or Class B) or an enhanced device class based on a performance category of STA MLD 1206 (e.g., Class 1: high-end performance, Class 2: medium performance, Class 3: low-end performance). In an embodiment, STA MLD 1206 may be an EHT STA MLD or a “Beyond 802.11be” STA MLD, and the device class of STA MLD 1206 may be included in an High-Efficiency (HE) Capabilities element. The device class may be indicated in a Device Class subfield of an HE physical layer (PHY) Information field of the HE PHY Capabilities element. In another embodiment, STA MLD 1206 may be an EHT STA MLD or a “Beyond 802.11be” STA MLD, and the device class of STA MLD 1206 may be included in an EHT Capabilities element. The device class may be indicated in a Device Class subfield of an EHT PHY Capabilities Information field of the EHT Capabilities element.

AP MLD 1202 may determine cross-link switching delay 1402 associated with STA MLD 1206 based on the device class of STA MLD 1206 included in frame 1502. In an embodiment, AP MLD 1202 may retrieve cross-link switching delay 1402, based on the device class of STA MLD 1206, from pre-configured information. The pre-configured information may include a look-up table of cross-link switching delay based on device class. When the signaled device class is as defined in section 36.3.16 of IEEE 802.11be, the look-up table may include two cross-link switching delay values depending on whether STA MLD 1206 is a Class A or a Class B device. When the signaled device class is based on an enhanced device class, the look-up table may include two or more cross-link switching delay values depending on the enhanced device class of STA MLD 1206 (e.g., Class 1: high-end performance, Class 2: medium performance, Class 3: low-end performance).

In another embodiment, the indication of cross-link switching delay 1402 in frame 1502 may be the EMLSR delay associated with STA MLD 1206. The EMLSR delay may be pre-configured at STA MLD 1206. AP MLD 1202 may determine cross-link switching delay 1402 based on the EMLSR delay indicated in frame 1502. Cross-link switching delay 1402 may be a fraction (e.g. (1/N)*EMLSR, where N is a positive integer) or a multiple of the EMLSR delay associated with STA MLD 1206.

In another embodiment, STA MLD 1206 may not transmit frame 1502 or frame 1502 may not include an indication of cross-link switching delay 1402 associated with STA MLD 1206. In such an embodiment, AP MLD 1202 may apply a default value for cross-link switching delay 1402 associated with STA MLD 1206. The default value may be chosen to be sufficiently long to accommodate STA MLDs across device class or performance category.

In the embodiments above, cross-link switching delay 1402 may be based on a cross-link power state (PS) transition delay or a power management mode (PM) transition delay. The cross-link PS transition delay includes a delay for a first STA, affiliated with a STA MLD and operating on a first link, to transition from a first power state to a second power state after the STA MLD receives a command on a second link that triggers the transition from the first power state to the second power state. The first power state may be a doze state and the second power state may be an awake state, or vice versa. The cross-link PM transition delay includes a delay for a first STA, affiliated with a STA MLD and operating on a first link, to transition from a first power management mode to a second power management mode after the STA MLD receives a command on the second link that triggers the transition from the first power management mode to the second power management mode. The first power management mode may be a power saving mode and the second power management mode may be an active mode, or vice versa.

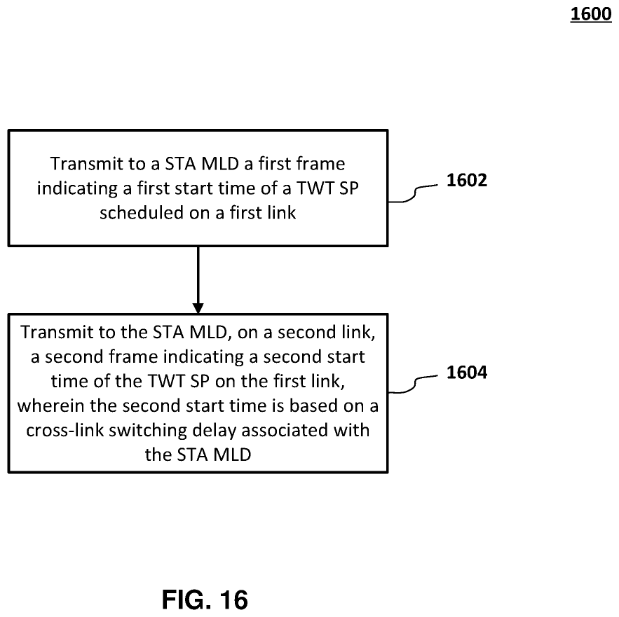

FIG. 16 illustrates an example process 1600 according to an embodiment. Example process 1600 is provided for the purpose of illustration only and is not limiting of embodiments. Example process 1600 may be performed by an AP MLD, such as AP MLD 1202, for example. As shown, example process 1600 includes steps 1602 and 1604.

In step 1602, example process 1600 may include transmitting, to a STA MLD, a first frame indicating a first start time of a TWT SP scheduled on a first link between the AP MLD and the STA MLD. In an example, the first frame may be a TWT setup response frame or a beacon frame.

In step 1604, example process 1600 may include transmitting, to the STA MLD, on a second link between the AP MLD and the STA MLD, a second frame indicating a second start time of the TWT SP on the first link, where the second start time is based on a cross-link switching delay associated with the STA MLD. In an embodiment, the second start time is at least the cross-link switching delay after the transmitting of the second frame on the second link.

In an embodiment, example process 1600 may include, before step 1604, receiving, by the AP MLD from the STA MLD, a third frame comprising the cross-link switching delay associated with the STA MLD. The third frame may include a probe request frame, a TWT setup request frame, an association request frame, an action frame, a control frame, or a Quality of Service (QoS) data or null frame.

In an embodiment, the cross-link switching delay may be based on a device class of the STA MLD. The device class may be as defined in section 36.3.16 of IEEE 802.11be (e.g., Class A or Class B) or an enhanced device class based on a performance category of the STA MLD (e.g., Class 1: high-end performance, Class 2: medium performance, Class 3: low-end performance).

In an embodiment, example process 1600 may include receiving, by the AP MLD from the STA MLD, the device class of the STA MLD. The device class may be carried in a probe request frame, a TWT setup request frame, an association request frame, an action frame, a control frame, a management frame, or a QoS data or null frame with an A-control field. In an embodiment, the STA MLD may be an EHT STA MLD or a “Beyond 802.11be” STA MLD, and the device class of STA MLD may be included in an High-Efficiency (HE) Capabilities element. The device class may be indicated in a Device Class subfield of an HE physical layer (PHY) Information field of the HE PHY Capabilities element. In another embodiment, the STA MLD may be an EHT STA MLD or a “Beyond 802.11be” STA MLD, and the device class of STA MLD may be included in an EHT Capabilities element. The device class may be indicated in a Device Class subfield of an EHT PHY Capabilities Information field of the EHT Capabilities element.

In an embodiment, example process 1600 may include determining, by the AP MLD, the cross-link switching delay based on the device class of the STA MLD. In an embodiment, determining the cross-link switching delay based on the device class of the STA MLD includes retrieving the cross-link switching delay, based on the device class of the STA MLD, from pre-configured information. The pre-configured information may include a look-up table of cross-link switching delay based on device class.

In an embodiment, the cross-link switching delay may be based on an EMLSR delay associated with the STA MLD. The cross-link switching delay may be a fraction or a multiple of the EMLSR delay associated with the STA MLD. In an embodiment, example process 1600 may further include receiving, by the AP MLD from the STA MLD, the EMLSR delay associated with the STA MLD. The EMLSR delay may be carried in a probe request frame, a TWT setup request frame, an association request frame, an action frame, a control frame, a management frame, or a QoS data or null frame with an A-control field.

In an embodiment, example process 1600 may further include determining, by the AP MLD, the cross-link switching delay based on the EMLSR delay associated with the STA MLD.

In an embodiment, example process 1600 may further include applying a default value for the cross-link switching delay associated with the STA MLD.

In an embodiment, the cross-link switching delay includes a cross-link power state PS transition delay. The cross-link PS transition delay includes a delay for a first STA, affiliated with the STA MLD and operating on the first link, to transition from a first power state to a second power state after the STA MLD receives a command on the second link that triggers the transition from the first power state to the second power state. The first power state may be a doze state and the second power state may be an awake state, or vice versa.

In another embodiment, the cross-link switching delay includes a cross-link PM transition delay. The cross-link PM transition delay includes a delay for a first STA, affiliated with the STA MLD and operating on the first link, to transition from a first power management mode to a second power management mode after the STA MLD receives a command on the second link that triggers the transition from the first power management mode to the second power management mode. The first power management mode may be a power saving mode and the second power management mode may be an active mode, or vice versa.

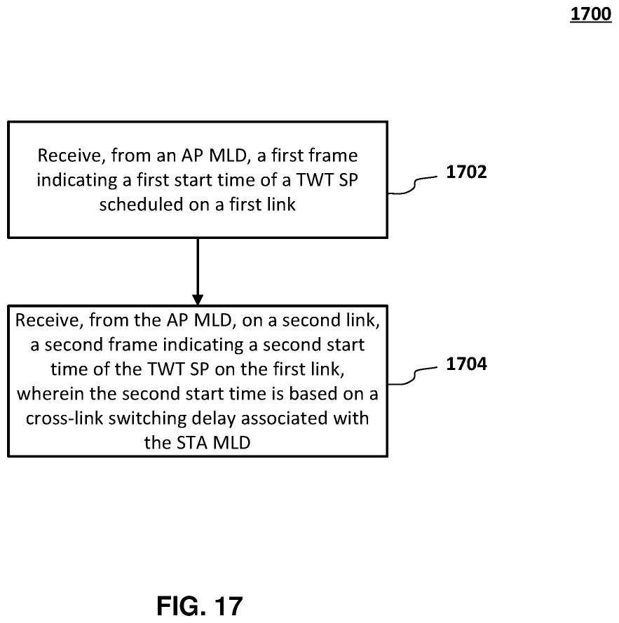

FIG. 17 illustrates an example process 1700 according to an embodiment. Example process 1700 is provided for the purpose of illustration only and is not limiting of embodiments. Example process 1700 may be performed by a STA MLD, such as STA MLD 1206, for example. As shown, example process 1700 includes steps 1702 and 1704.

In step 1702, example process 1700 may include receiving, from an AP MLD, a first frame indicating a first start time of a TWT SP scheduled on a first link between the AP MLD and the STA MLD. In an example, the first frame may be a TWT setup response frame or a beacon frame.

In step 1704, example process 1700 may include receiving, from the AP MLD, on a second link between the AP MLD and the STA MLD, a second frame indicating a second start time of the TWT SP on the first link, where the second start time is based on a cross-link switching delay associated with the STA MLD. In an embodiment, the second start time is at least the cross-link switching delay after the transmitting of the second frame on the second link.

In an embodiment, example process 1700 may include, before step 1704, transmitting, to the AP MLD, a third frame comprising the cross-link switching delay associated with the STA MLD. The third frame may include a probe request frame, a TWT setup request frame, an association request frame, an action frame, a control frame, or a Quality of Service (QoS) data or null frame. The value of the cross-link switching delay may be a pre-configured parameter of the STA MLD or may be determined by the STA MLD. For example, the STA MLD may determine the cross-link switching delay based on a device class of the STA MLD. The device class may be as defined in section 36.3.16 of IEEE 802.11be (e.g., Class A or Class B) or an enhanced device class based on a performance category of STA MLD 1206 (e.g., Class 1: high-end performance, Class 2: medium performance, Class 3: low-end performance). Alternatively or additionally, the STA MLD may determine the cross-link switching delay based on another delay value pre-configured at the STA MLD. For example, the STA MLD may determine the cross-link switching delay based on an EMLSR delay associated with the STA MLD. The cross-link switching delay may be determined as a fraction or a multiple of the EMLSR associated with the STA MLD.

In an embodiment, the cross-link switching delay may be based on the device class of the STA MLD. In an embodiment, example process 1700 may include transmitting, to the AP MLD, the device class of the STA MLD. The device class may be carried in a probe request frame, a TWT setup request frame, an association request frame, an action frame, a control frame, a management frame, or a QoS data or null frame with an A-control field. In an embodiment, the STA MLD may be an EHT STA MLD or a “Beyond 802.11be” STA MLD, and the device class of STA MLD may be included in an High-Efficiency (HE) Capabilities element. The device class may be indicated in a Device Class subfield of an HE physical layer (PHY) Information field of the HE PHY Capabilities element. In another embodiment, the STA MLD may be an EHT STA MLD or a “Beyond 802.11be” STA MLD, and the device class of STA MLD may be included in an EHT Capabilities element. The device class may be indicated in a Device Class subfield of an EHT PHY Capabilities Information field of the EHT Capabilities element.

In an embodiment, the cross-link switching delay may be based on an EMLSR delay associated with the STA MLD. The cross-link switching delay may be a fraction or a multiple of the EMLSR delay associated with the STA MLD. In an embodiment, example process 1700 may further include transmitting, to the AP MLD, the EMLSR delay associated with the STA MLD. The EMLSR delay may be carried in a probe request frame, a TWT setup request frame, an association request frame, an action frame, a control frame, a management frame, or a QoS data or null frame with an A-control field.

In an embodiment, the cross-link switching delay includes a cross-link power state PS transition delay. The cross-link PS transition delay includes a delay for a first STA, affiliated with the STA MLD and operating on the first link, to transition from a first power state to a second power state after the STA MLD receives a command on the second link that triggers the transition from the first power state to the second power state. The first power state may be a doze state and the second power state may be an awake state, or vice versa.

In another embodiment, the cross-link switching delay includes a cross-link PM transition delay. The cross-link PM transition delay includes a delay for a first STA, affiliated with the STA MLD and operating on the first link, to transition from a first power management mode to a second power management mode after the STA MLD receives a command on the second link that triggers the transition from the first power management mode to the second power management mode. The first power management mode may be a power saving mode and the second power management mode may be an active mode, or vice versa.

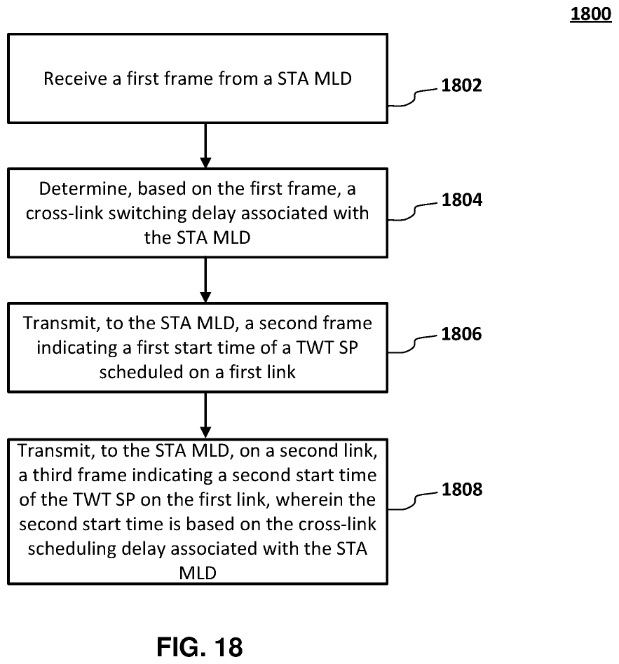

FIG. 18 illustrates an example process 1800 according to an embodiment. Example process 1800 is provided for the purpose of illustration only and is not limiting of embodiments. Example process 1800 may be performed by an AP MLD, such as AP MLD 1202, for example. As shown, example process 1800 includes steps 1802, 1804, 1806, and 1808.

In step 1802, example process 1800 may include receiving a first frame from a STA MLD. In an embodiment, the first frame may include a cross-link switching delay or an EMLSR associated with the STA MLD. In another embodiment, the first frame may include a device class of the STA MLD. In an embodiment, the first frame may include a probe request frame, a TWT setup request frame, an association request frame, an action frame, a control frame, or QoS data or null frame.

In step 1804, example process 1800 may include determining, based on the first frame, a cross-link switching delay associated with the STA MLD.

In step 1806, example process 1800 may include transmitting, to the STA MLD, a second frame indicating a first start time of a TWT SP scheduled on a first link between the AP MLD and the STA MLD.

In step 1808, example process 1800 may include transmitting, to the STA MLD, on a second link between the AP MLD and the STA MLD, a third frame indicating a second start time of the TWT SP on the first link, where the second start time is based on the cross-link switching delay associated with the STA MLD.

1. An access point (AP) multi-link device (MLD) comprising:
one or more processors; and
memory storing instructions that, when executed by the one or more processors, cause the AP MLD to:
transmit, to a station (STA) MLD, a first frame indicating a first start time of a target wake time (TWT) service period (SP) scheduled on a first link between the AP MLD and the STA MLD; and
transmit, to the STA MLD, on a second link between the AP MLD and the STA MLD, a second frame indicating a second start time of the TWT SP on the first link, wherein the second start time is based on a cross-link switching delay associated with the STA MLD.

2. The AP MLD of claim 1, wherein the cross-link switching delay is based on a device class of the STA MLD.

3. The AP MLD of claim 1, wherein the cross-link switching delay is based on an Enhanced Multi-Link Single Radio (EMLSR) delay associated with the STA MLD.

4. The AP MLD of claim 1, wherein the second start time is at least the cross-link switching delay after the transmitting of the second frame on the second link.

5. The AP MLD of claim 1, wherein the cross-link switching delay includes a cross-link power state (PS) transition delay or a cross-link power management mode (PM) transition delay.

6. The AP MLD of claim 5, wherein the cross-link PS transition delay includes a delay for a first STA, affiliated with the STA MLD and operating on the first link, to transition from a first power state to a second power state after the STA MLD receives a command on the second link that triggers the transition from the first power state to the second power state.

7. The AP MLD of claim 6, wherein the first power state is a doze state and the second power state is an awake state.

8. The AP MLD of claim 5, wherein the cross-link PM transition delay includes a delay for a first STA, affiliated with the STA MLD and operating on the first link, to transition from a first power management mode to a second power management mode after the STA MLD receives a command on the second link that triggers the transition from the first power management mode to the second power management mode.

9. The AP MLD of claim 8, wherein the first power management mode is a power saving mode and the second power management mode is an active mode.

10. A station (STA) multi-link device (MLD) comprising:
one or more processors; and
memory storing instructions that, when executed by the one or more processors, cause the STA MLD to:
receive, from an access point (AP) MLD, a first frame indicating a first start time of a target wake time (TWT) service period (SP) scheduled on a first link between the AP MLD and the STA MLD; and
receive, from the AP MLD, on a second link between the AP MLD and the STA MLD, a second frame indicating a second start time of the TWT SP on the first link, wherein the second start time is based on a cross-link switching delay associated with the STA MLD.

11. The STA MLD of claim 10, wherein the cross-link switching delay is based on a device class of the STA MLD.

12. The STA MLD of claim 10, wherein the cross-link switching delay is based on an Enhanced Multi-Link Single Radio (EMLSR) delay associated with the STA MLD.

13. The STA MLD of claim 10, wherein the second start time is at least the cross-link switching delay after the receiving of the second frame on the second link.

14. The STA MLD of claim 10, wherein the cross-link switching delay includes a cross-link power state (PS) transition delay or a cross-link power management mode (PM) transition delay.

15. The STA MLD of claim 14, wherein the cross-link PS transition delay includes a delay for a first STA, affiliated with the STA MLD and operating on the first link, to transition from a first power state to a second power state after the STA MLD receives a command on the second link that triggers the transition from the first power state to the second power state.

16. The STA MLD of claim 15, wherein the first power state is a doze state and the second power state is an awake state.

17. The STA MLD of claim 14, wherein the cross-link PM transition delay includes a delay for a first STA, affiliated with the STA MLD and operating on the first link, to transition from a first power management mode to a second power management mode after the STA MLD receives a command on the second link that triggers the transition from the first power management mode to the second power management mode.

18. The STA MLD of claim 17, wherein the first power management mode is a power saving mode and the second power management mode is an active mode.

19. A non-transitory computer-readable medium comprising instructions that, when executed by one or more processors, cause an access point (AP) multi-link device (MLD) to:
transmit, to a station (STA) MLD, a first frame indicating a first start time of a target wake time (TWT) service period (SP) scheduled on a first link between the AP MLD and the STA MLD; and
transmit, to the STA MLD, on a second link between the AP MLD and the STA MLD, a second frame indicating a second start time of the TWT SP on the first link, wherein the second start time is based on a cross-link switching delay associated with the STA MLD.

20. The non-transitory computer-readable medium of claim 19, wherein the second start time is at least the cross-link switching delay after the transmitting of the second frame on the second link.
